(19) United States
(12) Patent Application Publication
(10) Pub. No.: US 2011/0142662 A1
(43) Pub. Date: Jun. 16, 2011

(54) Spar Cap Assembly for a Wind Turbine Rotor Blade

(75) Inventors: Peter James Fritz, Greenville, SC (US); Bruce Clark Busbey, Greer, SC (US); Thomas Merzhaeuser, Lingen (DE)

(73) Assignee: GENERAL ELECTRIC COMPANY, Schenectady, NY (US)

(21) Appl. No.: 12/914,589

(22) Filed: Oct. 28, 2010

(51) Int. Cl. F03D 11/00

(52) U.S. Cl. 416/226; 416/233

(57) ABSTRACT

A spar cap assembly for a rotor blade of a wind turbine is disclosed. In general, the spar cap assembly may include a tensile spar cap formed from a composite material and configured to engage an inner surface of the rotor blade. The tensile spar cap may generally have a first thickness and a first cross-sectional area. Additionally, the spar cap assembly may include a compressive spar cap formed from the same composite material and configured to engage an opposing inner surface of the rotor blade. The compressive spar cap may generally have a second thickness and a second cross-sectional area that is greater than the first cross-sectional area. Additionally, the composite material is generally selected so that at least one of a strength and a modulus of elasticity of the composite material differs depending on whether the material is in tension or in compression.

### FIELD OF THE INVENTION

The present subject matter relates generally to rotor blades for a wind turbine and, more particularly, to a spar cap assembly for a rotor blade having differing thicknesses.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy from wind using known foil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

Wind turbine rotor blades generally include a shell body formed by two shell halves of a composite laminate material. The shell halves are generally manufactured using molding processes and then coupled together along the corresponding edges of the rotor blade. In general, the shell body is relatively lightweight and has structural properties (e.g., stiffness, buckling resistance and strength) which are not configured to withstand the bending moments and other loads exerted on the rotor bade during operation. To increase the stiffness, buckling resistance and strength of the rotor blade, the body shell is typically reinforced using spar caps that engage the inner surfaces of the shell halves. As such, flapwise or spanwise bending moments and loads, which cause a rotor blade tip to deflect towards the wind turbine tower, are generally transferred along the rotor blade through the spar caps.

With the continuously increasing length of rotor blades in recent years, meeting strength and stiffness requirements has become a major concern in the structural design of a rotor blade. As such, conventional blade designs are generally over-strengthened and/or over-stiffened. In particular, spar caps are typically designed to be symmetrical, having the same widths, thicknesses and cross-sectional areas. This generally results in a heavy design having a relatively high blade mass and/or a relatively expensive design due to unnecessary material costs.

Accordingly, there is a need for a spar cap design that allows for a reduction in blade mass and/or material costs without sacrificing the performance of the rotor blade.

### BRIEF DESCRIPTION OF THE INVENTION

Aspects and advantages of the invention will be set forth in part in the following description, or may be obvious from the description, or may be learned through practice of the invention.

In one aspect, the present subject matter discloses a spar cap assembly for a rotor blade of a wind turbine. In general, the spar cap assembly may include a tensile spar cap formed from a composite material and configured to engage an inner surface of the rotor blade. The tensile spar cap may generally have a first thickness and a first cross-sectional area. Additionally, the spar cap assembly may include a compressive spar cap formed from the same composite material and configured to engage an opposing inner surface of the rotor blade. The compressive spar cap may generally have a second thickness and a second cross-sectional area that is greater than the first cross-sectional area. Additionally, the composite material is generally selected so that at least one of a strength and a modulus of elasticity of the composite material differs depending on whether the material is in tension or in compression.

In another aspect, the present subject matter discloses a rotor blade for a wind turbine. The rotor blade may generally include a body shell extending between a root end and a tip end and including a first inner surface and a second inner surface. The rotor blade may also include a tensile spar cap and a compressive spar cap. The tensile spar cap may generally be formed from a composite material and may be configured to engage the first inner surface of the body shell. Additionally, the tensile spar cap may have a first thickness and a first cross-sectional area. The compressive spar cap may generally be formed from the same composite material and may be configured to engage the second inner surface of the body shell. Further, the compressive spar cap may generally have a second thickness and a second cross-sectional area that is greater than the first cross-sectional area. Further, the composite material is generally selected so that at least one of a strength and a modulus of elasticity of the composite material differs depending on whether the material is in tension or in compression.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of a wind turbine of conventional construction;

FIG. 2 illustrates a perspective view of one embodiment of a rotor blade; and

FIG. 3 illustrates a cross-sectional view of the rotor blade shown in FIG. 2, particularly illustrating the structural components of the rotor blade.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a rotor blade having spar caps of dissimilar thicknesses. In particular, the present subject matter discloses spar caps, formed from the same composite material, which have differing thicknesses depending on the tensile and compressive properties of the composite material. For example, when the tensile strength and/or modulus of elasticity of a composite material is greater than its compressive strength and/or modulus of elasticity, the thickness of the spar cap loaded in tension may be reduced and the thickness of the spar cap loaded in compression may be increased as compared to a pair of symmetrical spar caps. In doing so, it has been observed by the inventors of the present subject matter that the necessary increase in thickness of the spar cap loaded in compression is generally less than the overall reduction in thickness that can be made to the spar cap loaded in tension without sacrificing the bending strength, stiffness or buckling resistance of the rotor blade. Accordingly, it has been found that an overall reduction in material costs and blade mass may be achieved by altering the thickness of otherwise symmetrical rotor blades spar caps to accommodate for the variations in the tensile and compressive strengths and/or moduli of many composite materials.

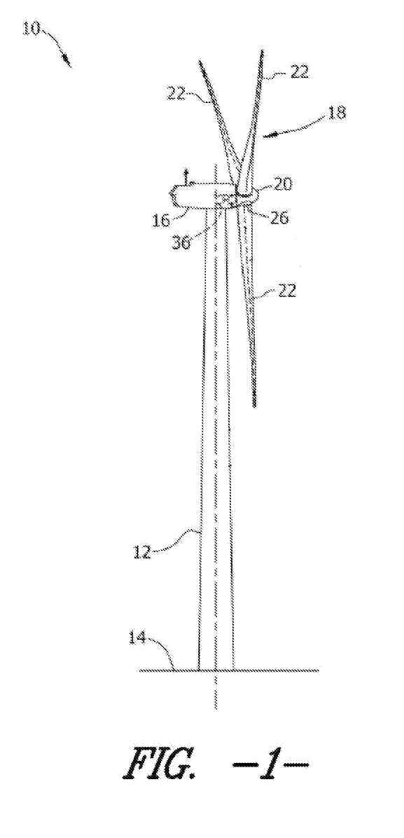

Referring now to the drawings. FIG. 1 illustrates a perspective view of a wind turbine 10 of conventional construction. As shown, the wind turbine 10 is a horizontal-axis wind turbine. However, it should be appreciated that the wind turbine 10 may be a vertical-axis wind turbine. In the illustrated embodiment, the wind turbine 10 includes a tower 12 that extends from a support surface 14, a nacelle 16 mounted on the tower 12, and a rotor 18 that is coupled to the nacelle 16. The rotor 18 includes a rotatable hub 20 and at least one rotor blade 22 coupled to and extending outward from the hub 20. As shown, the rotor 18 includes three rotor blades 22. However, in an alternative embodiment, the rotor 18 may include more or less than three rotor blades 22. Additionally, in the illustrated embodiment, the tower 12 is fabricated from tubular steel to define a cavity (not illustrated) between the support surface 14 and the nacelle 16. In an alternative embodiment, the tower 12 may be any suitable type of tower having any suitable height.

The rotor blades 22 may generally have any suitable length that enables the wind turbine 10 to function as described herein. Additionally, the rotor blades 22 may be spaced about the hub 20 to facilitate rotating the rotor 18 to enable kinetic energy to be transferred from the wind into usable mechanical energy, and subsequently, electrical energy. Specifically, the hub 20 may be rotatably coupled to an electric generator (not illustrated) positioned within the nacelle 16 to permit electrical energy to be produced. Further, the rotor blades 22 may be mated to the hub 20 at a plurality of load transfer regions 26. Thus, any loads induced to the rotor blades 22 are transferred to the hub 20 via the load transfer regions 26.

As shown in the illustrated embodiment, the wind turbine may also include a turbine control system or turbine controller 36 centralized within the nacelle 16. However, it should be appreciated that the controller 36 may be disposed at any location on or in the wind turbine 10, at any location on the support surface 14 or generally at any other location. The controller 36 may generally be configured to control the various operating modes of the wind turbine 10 (e.g., start-up or shut-down sequences).

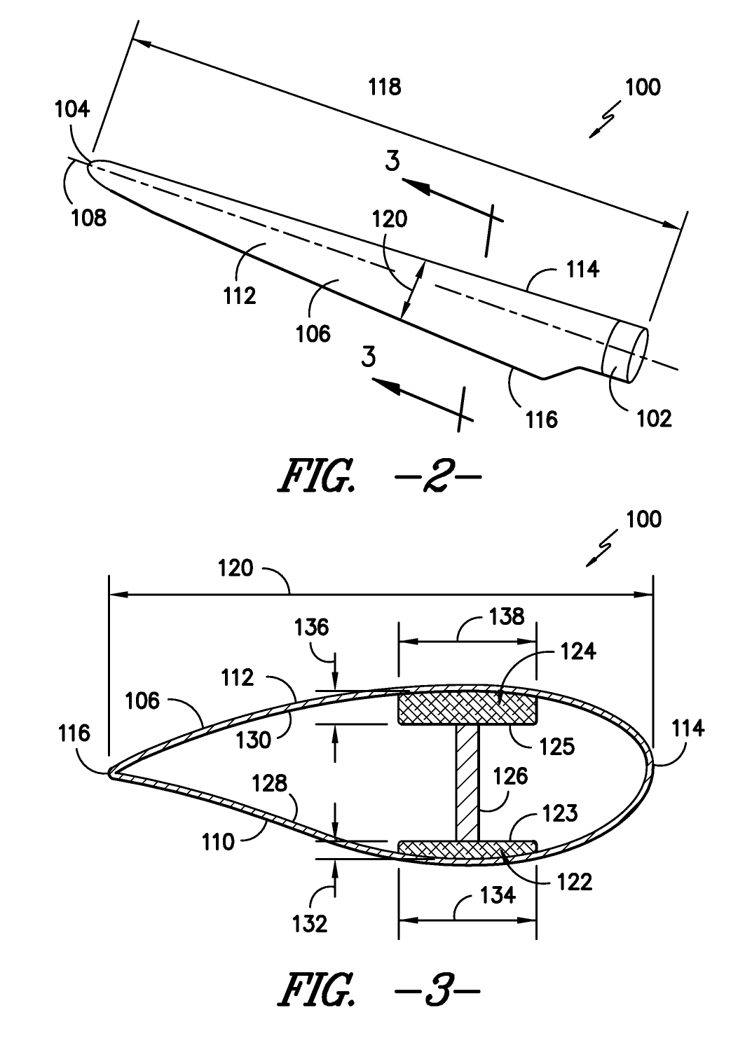

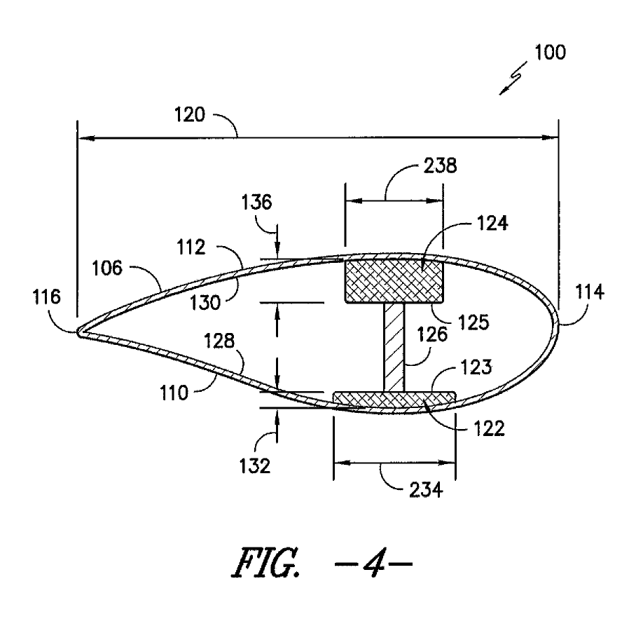

Referring now to FIGS. 2 and 3, one embodiment of a rotor blade 100 for use with a wind turbine 10 is illustrated in accordance with aspects of the present subject matter. In particular, FIG. 2 illustrates a perspective view of the embodiment of the rotor blade 100. FIG. 3 illustrates a cross-sectional view of the rotor blade 100 along the sectional line 3-3 shown in FIG. 2.

As shown, the rotor blade 100 generally includes a root end 102 configured to be mounted or otherwise secured to the hub 20 (FIG. 1) of a wind turbine 10 and a tip end 104 disposed opposite the root end 102. A body shell 106 of the rotor blade generally extends between the root end 102 and the tip end 104 along a longitudinal axis 108. The body shell 106 may generally serve as the outer casing/covering of the rotor blade 100 and may define a substantially aerodynamic profile, such as by defining a symmetrical or cambered airfoil-shaped cross-section. The body shell 106 may also define a pressure side 110 and a suction side 112 extending between leading and trailing edges 114, 116 of the rotor blade 100. Further, the rotor blade 100 may also have a span 118 defining the total length between the root end 100 and the tip end 102 and a chord 120 defining the total length between the leading edge 114 and the trailing edge 116. As is generally understood, the chord 120 may generally vary in length with respect to the span 118 as the rotor blade 100 extends from the root end 102 to the tip end 104.

In several embodiments, the body shell 106 of the rotor blade 100 may be formed as a single, unitary component. Alternatively, the body shell 106 may be formed from a plurality of shell components. For example, the body shell 106 may be manufactured from a first shell half generally defining the pressure side 110 of the rotor blade 100 and a second shell half generally defining the suction side 112 of the rotor blade 100, with such shell halves being secured to one another at the leading and trailing edges 114, 116 of the blade 100. Additionally, the body shell 106 may generally be formed from any suitable material. For instance, in one embodiment, the body shell 106 may be formed entirely from a laminate composite material, such as a carbon fiber reinforced laminate composite or a glass fiber reinforced laminate composite. Alternatively, one or more portions of the body shell 106 may be configured as a layered construction and may include a core material, formed from a lightweight material such as wood (e.g., balsa), foam (e.g., extruded polystyrene foam) or a combination of such materials, disposed between layers of laminate composite material.

Referring particularly to FIG. 3, the rotor blade 100 may also include one or more longitudinally extending structural components configured to provide increased stiffness, buckling resistance and/or strength to the rotor blade 100. For example, the rotor blade 100 may include a pair of longitudinally extending spar caps 122, 124 configured to be engaged against the opposing inner surfaces 128, 130 of the pressure and suction sides 110, 112 of the body shell 106, respectively. Additionally, one or more shear webs 126 may be disposed between the spar caps 122, 124 so as to form a beam-like configuration. The spar caps 122, 124 may generally be designed to control the bending stresses and/or other loads acting on the rotor blade 100 in a generally spanwise direction (a direction parallel to the span 118 of the rotor blade 100) during operation of a wind turbine 10. For instance, bending stresses may occur on a rotor blade 100 when the wind loads directly on the pressure side 112 of the blade 100, thereby subjecting the pressure side 112 to spanwise tension and the suction side 110 to spanwise compression as the rotor blade 100 bends in the direction of the wind turbine tower 12 (FIG. 1).

Thus, in accordance with aspects of the present subject matter, the spar cap 122 disposed on the pressure side 110 of the rotor blade 100 (hereinafter referred to as the “tensile spar cap 122”) may generally be configured to withstand the spanwise tension occurring as the rotor blade 100 is subjected to various bending moments and other loads during operation. Similarly, the spar cap 124 disposed on the suction side 112 of the rotor blade 100 (hereinafter referred to as the “compressive spar cap 124”) may generally be configured to withstand the spanwise compression occurring during operation of the wind turbine 10. Specifically, the tensile and compressive spar caps 122, 124 may each include a cross-sectional area equal to a product of a spar cap thickness and a chordwise width of each spar cap 122, 124 as measured along the chord 120 defined between the leading edge 114 and the trailing edge 116. For example, as shown in FIG. 3, the tensile spar cap 122 may generally have a first thickness 132 (defined as the maximum thickness between the inner face 123 of the tensile spar cap 122 and the inner surface 128 of the body shell 106) and a first chordwise width 132. Additionally, the compressive spar cap 124 may generally have a second thickness 136 (defined as the maximum thickness between the inner face 125 of the compressive spar cap 124 and the inner surface 130 of the body shell 106) and a second chordwise width 138. As will be described below, depending on the properties of the material utilized to form the spar caps 122, 124, the tensile and compressive spar caps 122, 124 may generally be configured to define differing thicknesses 132, 136 and differing cross-sectional areas without any performance penalty.

In general, the tensile and compressive spar caps 122, 124 may be formed from any suitable composite material that has material properties (e.g., strengths and/or moduli of elasticity) which vary depending on whether the composite is in compression or in tension. Additionally, the tensile and compressive spar caps 122, 124 may generally be formed from the same composite material. Thus, in several embodiments of the present subject matter, both the tensile and compressive spar caps 122, 124 may be formed from any suitable laminate composite material which has a tensile strength and/or modulus of elasticity that varies from the composite's compressive strength and/or modulus of elasticity. Suitable laminate composite materials may include laminate composites reinforced with carbon, mixtures of carbon, fiberglass, mixtures of fiberglass, mixtures of carbon and fiberglass and any other suitable reinforcement material and mixtures thereof. For example, in a particular embodiment of the present subject matter, both the tensile and compressive spar caps 122, 124 may be formed from a carbon fiber reinforced laminate composite which has a tensile strength and/or modulus that is greater than the composite's compressive strength and/or modulus.

It should be appreciated by those of ordinary skill in the art that numerous different fiber reinforced laminate composites are known that have varying ratios of tensile/compressive strengths and/or tensile/compressive moduli of elasticity. For example, carbon fiber reinforced laminate composites are commercially available in which the percent difference between the tensile strength and the compressive strength ranges from greater than 0% to about 85%, such as from about 20% to about 80% or from about 55% to about 75% and all other subranges therebetween. Additionally, carbon fiber reinforced laminate composites are commercially available in which the percent difference between the tensile modulus of elasticity and the compressive modulus of elasticity ranges from greater than 0% to about 55%, such as from about 10% to about 50% or from about 15% to about 30% and all other subranges therebetween. It should be appreciated that, as used herein, the percent differences between the tensile and compressive properties are defined as the difference between the tensile property and compressive property divided by the tensile property. Thus, the percent difference in the tensile/compressive strength of a particular composite material equals the difference between the tensile strength and the compressive strength of the composite divided by its tensile strength.

By recognizing such variations in the tensile and compressive properties of many composite materials, it has been found that the thickness 132 of the tensile spar cap 122 may generally be reduced by an amount greater than the increase needed in the thickness 136 of the compressive spar cap 124 to maintain the same rigidity, buckling resistance and/or strength that may otherwise be present in a rotor blade when symmetrical spar caps (e.g., spar caps having the same thicknesses, widths and cross-sectional areas) are utilized. As such, an overall reduction in blade mass and material costs can be achieved without sacrificing the performance of the rotor blade 100.

It should be appreciated that the difference in magnitude of the thicknesses 132, 136 of the tensile and compressive spar caps 122, 124 may generally vary depending on the overall difference in the tensile and compressive properties of the composite material used to form the spar caps 122, 124. However, in several embodiments of the present subject matter, the percent difference in the thicknesses 132, 136 between the tensile spar cap 122 and the compressive spar cap 124 may generally range from greater than 0% to about 70%. Specifically, for a composite material in which the percent difference between the tensile strength and the compressive strength ranges from greater than 0% to about 85%, the percent difference between the thickness 132 of the tensile spar cap 122 and the thickness 136 of the compressive spar cap 124 may generally range from greater than 0% to about 70%, such as from about 10% to about 65% or from about 35% to about 60% and all other subranges therebetween. However, for composite materials in which the percent difference between the tensile strength and the compressive strength is greater than 85%, it is foreseen that the percent difference in the thicknesses 132, 136 may be greater than 70%. Additionally, for a composite material in which the percent difference between the tensile modulus of elasticity and the compressive modulus of elasticity ranges from greater than 0% to about 55%, the percent difference between the thickness 132 of the tensile spar cap 122 and the thickness 136 of the compressive spar cap 124 may generally range from greater than 0% to about 45%, such as from about 10% to about 40% or from about 15% to about 35% and all other subranges therebetween. However, for composite materials in which the percent difference between the tensile modulus of elasticity and the compressive modulus of elasticity is greater than 55%, it is foreseen that the percent difference in the thicknesses 132, 136 may be greater than 45%. It should be appreciated that, as used herein, the percent difference in thicknesses 132, 136 between the tensile and compressive spar caps 122, 124 is defined as the difference between the thickness 132 of the tensile spar cap 122 and the thickness 136 of the compressive spar cap 124 divided by the thickness 132 of the tensile spar cap 122.

Additionally, when the thickness 136 of the compressive spar cap 124 is configured to be greater than the thickness 132 of the tensile spar cap 122, the cross-sectional area of the compressive spar cap 124 may also be greater than the cross-sectional area of the tensile spar cap 122. Thus, in one embodiment, the chordwise width 138 of the compressive spar cap 124 may be substantially equal to the chordwise width 134 of the tensile spar cap 122. As such, the difference in the cross-sectional areas of the tensile and compressive spar caps 122, 124 may be directly proportional to the thickness differential of the spar caps 122, 124. Accordingly, in a particular embodiment, the cross-sectional area of the compressive spar cap 124 may be greater than the cross-sectional area of the tensile spar cap 122 by a percent difference of up to about 70%, such as from about 10% to about 65% or from about 35% to about 60% and all other subranges therebetween. Alternatively, the chordwise widths 134, 138 of the tensile and compressive spar caps 122, 124 may be varied while still maintaining the difference in the cross-sectional areas of the spar caps 122, 124.

It should also be appreciated that the thicknesses 132, 136 and widths 134, 138 of the each spar cap 122, 124 may generally vary along the span 118 of the rotor blade 100. For instance, in several embodiments, the thicknesses 132, 136 and/or widths 134, 138 of the tensile and compressive spar caps 122, 124 may decrease or increase as the spar caps 122, 124 extend from the root end 102 of the rotor blade 100 towards the tip end 104. In such embodiments, the percent difference in relative thickness between the tensile and compressive spar caps 122, 124 may remain constant along the length of the span 118 or may be increased or decreased along the length of the span 118. Similarly, in embodiments in which the thicknesses 132, 136 and/or widths 134, 138 of the tensile and compressive spar caps 122, 124 remain constant along the span 118 of the rotor blade 100, the percent in relative thickness between the tensile and compressive spar caps 122, 124 may remain constant or may be increased or decreased along the length of the span 118.

Further, it should be appreciated that, in alternative embodiments of the present subject matter, the rotor blade 100 may be configured such that the pressure side 110 of the blade 100 is subjected to compressive forces while the suction side 112 of the blade 100 is subjected to tensile forces. In such an embodiment, the tensile spar cap 122 may generally be disposed on the suction side 112 of the rotor blade 100 while the compressive spar cap 124 is disposed on the pressure side 110. Additionally, in one or more embodiments, the tensile and compressive spar caps 122, 124 may be formed from a composite material in which the compressive strength and/or modulus is greater than the tensile strength and/or modulus. In such embodiments, the thickness 132 of the tensile spar cap 122 may be designed to be greater than the thickness 136 of the compressive spar cap 124. Moreover, in a further alternative embodiment of the present subject matter, the tensile spar cap 122 may be formed from a different composite material than the compressive spar cap 124.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A spar cap assembly for a rotor blade of a wind turbine, the spar cap assembly comprising:
a tensile spar cap formed from a composite material and configured to engage an inner surface of the rotor blade, the tensile spar cap having a first thickness and a first cross-sectional area; and,
a compressive spar cap formed from the same composite material and configured to engage an opposing inner surface of the rotor blade, the compressive spar cap having a second thickness and a second cross-sectional area that is greater than the first cross-sectional area,
wherein the composite material is selected so that at least one of a strength and a modulus of elasticity of the composite material differs depending on whether the composite material is in tension or in compression.

2. The spar cap assembly of claim 1, wherein the second cross-sectional area of the compressive spar cap is greater than the first cross-sectional area of the tensile spar cap by a percent difference of up to about 70%.

3. The spar cap assembly of claim 1, wherein the composite material comprises a laminate composite reinforced with at least one of carbon, fiberglass, mixtures of carbon, mixtures of fiberglass and mixtures of carbon and fiberglass.

4. The spar cap assembly of claim 1, wherein the composite material comprises a carbon fiber reinforced laminate composite.

5. The spar cap assembly of claim 1, wherein the tensile spar cap has a first width and the compressive spar cap has a second width, the first width being substantially equal to the second width.

6. The spar cap assembly of claim 1, wherein the tensile spar cap has a first width and the compressive spar cap has a second width, the first width differing from the second width.

7. The spar cap assembly of claim 1, wherein the second thickness of the compressive spar cap is greater than the first thickness of the tensile spar cap.

8. The spar cap assembly of claim 7, wherein the composite material has a tensile strength that differs from a compressive strength, the tensile strength being greater than the compressive strength by a percent difference of up to about 85%.

9. The spar cap assembly of claim 8, wherein the second thickness of the compressive spar cap is greater than the first thickness of the tensile spar cap by a percent difference of up to about 70%.

10. The spar cap assembly of claim 7, wherein the composite material has a tensile modulus of elasticity that differs from a compressive modulus of elasticity, the tensile modulus of elasticity being greater than the compressive modulus of elasticity by a percent difference of up to about 55%.

11. The spar cap assembly of claim 10, wherein the second thickness of the compressive spar cap is greater than the first thickness of the tensile spar cap by a percent difference of up to about 45%.

12. The spar cap assembly of claim 1, wherein the tensile spar cap is configured to engage the inner surface of a pressure side of the rotor blade and the compressive spar cap is configured to engage the inner surface of a suction side of the rotor blade.

13. A rotor blade for a wind turbine, the rotor blade comprising:
a body shell extending between a root end and a tip end, the body shell including a first inner surface disposed on a pressure side of the rotor blade and a second inner surface disposed on a suction side of the rotor blade;
a tensile spar cap formed from a composite material and configured to engage the first inner surface of the body shell, the tensile spar cap having a first thickness and a first cross-sectional area; and,
a compressive spar cap formed from the same composite material and configured to engage the second inner surface of the body shell, the compressive spar cap having a second thickness and a second cross-sectional area that is greater than the first cross-sectional area,
wherein the composite material is selected so that at least one of a strength and a modulus of elasticity of the composite material differs depending on whether the composite material is in tension or in compression.

14. The rotor blade of claim 13, wherein the second cross-sectional area of the compressive spar cap is greater than the first cross-sectional area of the tensile spar cap by a percent difference of up to about 70%.

15. The rotor blade of claim 13, wherein the composite material comprises a laminate composite reinforced with at least one of carbon, fiberglass, mixtures of carbon, mixtures of fiberglass and mixtures of carbon and fiberglass.

16. The rotor blade of claim 13, wherein the second thickness of the compressive spar cap is greater than the first thickness of the tensile spar cap.

17. The rotor blade of claim 16, wherein the composite material has a tensile strength that differs from a compressive strength, the tensile strength being greater than the compressive strength by a percent difference of up to about 85%.

18. The rotor blade of claim 17, wherein the second thickness of the compressive spar cap is greater than the first thickness of the tensile spar cap by a percent difference of up to about 0% to about 70%.

19. The rotor blade of claim 16, wherein the composite material has a tensile modulus of elasticity that differs from a compressive modulus of elasticity, the tensile modulus of elasticity being greater than the compressive modulus of elasticity by a percent difference of up to about 55%.

20. The rotor blade of claim 19, wherein the second thickness of the compressive spar cap is greater than the first thickness of the tensile spar cap by a percent difference of up to about 45%.
